(19) United States
(12) Patent Application Publication
(10) Pub. No.: US 2014/0348352 A1
(43) Pub. Date: Nov. 27, 2014

(54) LINE ARRAY SPEAKER

(71) Applicant: Sharp Kabushiki Kaisha, Osaka-shi, Osaka (JP)

(72) Inventors: Hisao Hattori, Osaka-shi (JP); Junsei Sato, Osaka-shi (JP)

(21) Appl. No.: 14/361,735

(22) PCT Filed: Nov. 29, 2012
(86) PCT No.: PCT/JP2012/080865

§ 371 Date: May 30, 2014

(30) Foreign Application Priority Data
Dec. 2, 2011 (JP) 2011-264885

(51) Int. Cl. H04R 1/02

(52) U.S. Cl. CPC H04R 1/02; H04R 2400/11
USPC 381/182

(57) ABSTRACT

A line array speaker in which interference between back pressures of adjacent speakers is reduced is provided. The line array speaker includes three or more cone-shaped speaker units including diaphragms vibrated by magnetic circuit portions. The speaker units are attached to a rectangular baffle plate 2 such that the speaker units are arranged side by side along a single line in the longitudinal direction of the baffle plate 2. The diaphragms are supported by respective frames 10 which are formed by aluminum die casting and which have openings 10a, 10a in upper and lower regions. Each frame 10 has no opening 10a in at least one region in an arrangement direction of the speaker units. Alternatively, the frame 10 of each speaker unit is configured so that the area of openings 10a, 10a in the regions in the arrangement direction is smaller than the area of openings 10a, 10a in other regions.

### TECHNICAL FIELD

The present invention relates to a line array speaker including three or more speaker units.

### BACKGROUND ART

Humans recognize an acoustic space based on differences between the magnitudes of sounds input to both ears and the times at which the sounds were input. Based on this fact, the following methods have been used: a method of causing two left and right speaker units to sense sounds recorded by stereo recording, and a method of emitting acoustic waves having a pressure difference from left and right speaker units so that it seems as if a sound is coming from a position between the speaker units.

However, a sound pressure difference and a time difference occur depending on the position because, for example, the acoustic waves emitted from the left and right speaker units attenuate with increasing distance and there is a difference in propagation time between the acoustic waves. For example, when the acoustic waves are set by using a listener on a central line, which is a line that is equally spaced from the two left and right speaker units, as a reference, the desired effect of the above-described methods cannot be achieved for listeners at positions outside the central line.

An example of a method for solving this problem is wave field synthesis (WFS), which is one of wavefront synthesis technologies (see NPL 1). With the WFS, a wavefront of an acoustic wave itself is reproduced by superimposing acoustic waves emitted from speaker units driven by different signals, thereby allowing listeners in a large area to sense that a sound source is at an intended position. An example of a speaker used for the WFS is a line array speaker including three or more speaker units arranged side by side along a single line, as described in PTL 1.

FIG. 9 is a schematic diagram illustrating a line array speaker according to the related art. In the line array speaker according to the related art, a frame of each speaker unit has openings for releasing a back pressure generated when a sound is emitted from a cone-shaped diaphragm. In this type of speaker unit, the back pressure is released not only in the vibrating direction of the diaphragm but also in the arrangement direction of the speaker units, the arrangement direction being perpendicular to the vibrating direction. Therefore, a significant interference occurs between the back pressures released from the speaker units in the arrangement direction. The interference between the back pressures released from the adjacent speaker units causes a problem in that the desired wavefront cannot be synthesized. Furthermore, there also arises a problem in that acoustic waves of certain frequencies will be amplified and the amplitudes of the diaphragms will be increased, which causes distortion of the diaphragms, and in that acoustic waves of certain frequencies will be attenuated as a result of the interference between the back pressures.

### CITATION LIST

### Patent Literature

PTL 1: Japanese Unexamined Patent Application Publication No. 2007-235709

### Non Patent Literature

NPL 1: A. J. Berkhout, D. de Vries, and P. Vogel, “Acoustic Control by Wave Field Synthesis” (Netherlands), 93 (5), Journal of the Acoustical Society of America (J. Acoust. Soc.), May 1993, p. 2764-2778

### SUMMARY OF INVENTION

### Technical Problem

In view of the above-described problems, an object of the present invention is to provide a line array speaker in which interference between back pressures of adjacent speakers is reduced.

### Solution to Problem

A line array speaker according to the present invention includes three or more cone-shaped speaker units arranged side by side along a single line, and is characterized in that each speaker unit includes a frame having no opening in at least one region of a side surface of the frame in an arrangement direction.

According to the present invention, since the frame has no opening in at least one region in the arrangement direction, an arrangement-direction component of a back pressure generated when each speaker unit emits a sound is blocked. Therefore, the interference between the back pressures released from the adjacent speaker units can be reduced.

A line array speaker according to the present invention includes three or more cone-shaped speaker units arranged side by side along a single line, and is characterized in that each speaker unit includes a frame having an opening in a region of a side surface of the frame in an arrangement direction, an area of the opening being smaller than an area of an opening in another region of the side surface.

According to the present invention, since the area of the opening in the region of the side surface of the frame in the arrangement direction is smaller than the area of the opening in another region of the side surface, the interference between the back pressures can be reduced in the arrangement-direction region. In addition, since the back pressure is released also from the region in the arrangement direction, the air resistance applied to the diaphragm can be reduced, and sound can be appropriately emitted from the diaphragm.

In the line array speaker according to the present invention, each speaker unit includes a magnetic circuit portion, and the frame has a hole, and a signal terminal of the magnetic circuit is attached to the hole.

According to the present invention, an electrode terminal is provided on the frame, so that it is not necessary to use a terminal plate that blocks the openings. Therefore, the back pressure can be released through the openings that are not blocked.

In the line array speaker according to the present invention, the hole is formed in the region of the side surface of the frame in the arrangement direction.

According to the present invention, since the hole is formed in the region of the side surface of the frame in the arrangement direction, the region of the side surface of the frame in the arrangement direction, the region having a greater area than regions in other directions, can be effectively utilized.

### Advantageous Effects of Invention

According to the present invention, since the frame of each speaker unit has no opening in at least one region of a side surface of the frame in the arrangement direction, the interference between back pressures can be reduced. Alternatively, since the area of the opening in the region of the side surface of the frame in the arrangement direction is smaller than that of the opening in another region of the side surface, the interference between back pressures can be reduced.

### BRIEF DESCRIPTION OF DRAWINGS

FIG. 1 is a schematic diagram illustrating a line array speaker according to a first embodiment.

FIG. 2 is a schematic top view of speaker units according to the first embodiment.

FIG. 3 is a schematic back view of the speaker units according to the first embodiment.

FIG. 4 is a schematic vertical sectional view of each speaker unit according to the first embodiment.

FIG. 5 is a block diagram of an acoustic apparatus including the line array speaker.

FIG. 6 is a schematic back view of a line array speaker according to a second embodiment.

FIG. 7 is a block diagram of an acoustic apparatus including the line array speaker.

FIG. 8 is a schematic back view of a line array speaker according to a third embodiment.

FIG. 9 is a schematic diagram illustrating a line array speaker according to the related art.

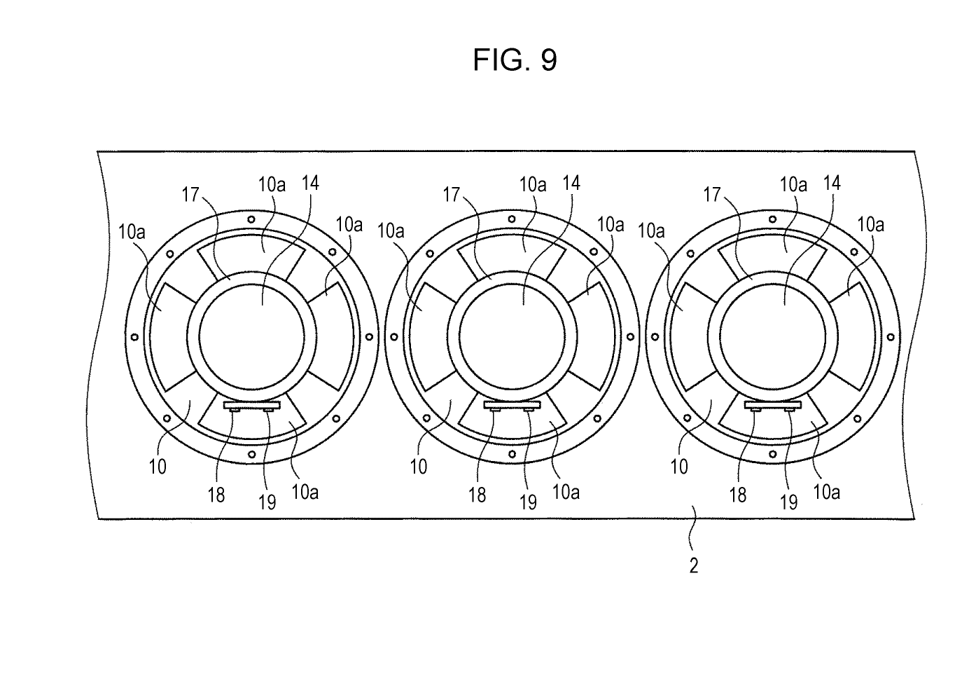

### DESCRIPTION OF EMBODIMENTS

### First Embodiment

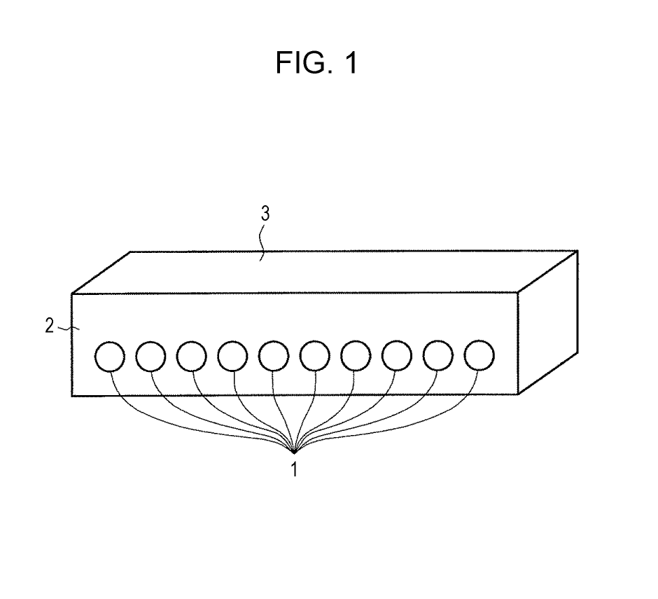

FIG. 1 is a schematic diagram illustrating a line array speaker according to a first embodiment. Referring to FIG. 1, cone-shaped speaker units 1, 1, 1, . . . are attached to a rectangular baffle plate 2 such that they are arranged side by side along a single line in the longitudinal direction of the baffle plate 2. The baffle plate 2 defines a front surface of a rectangular-parallelepiped-shaped housing 3 that houses the speaker units 1, 1, 1, . . . . The housing 3 is arranged so that the longitudinal direction of the baffle plate 2 is horizontal.

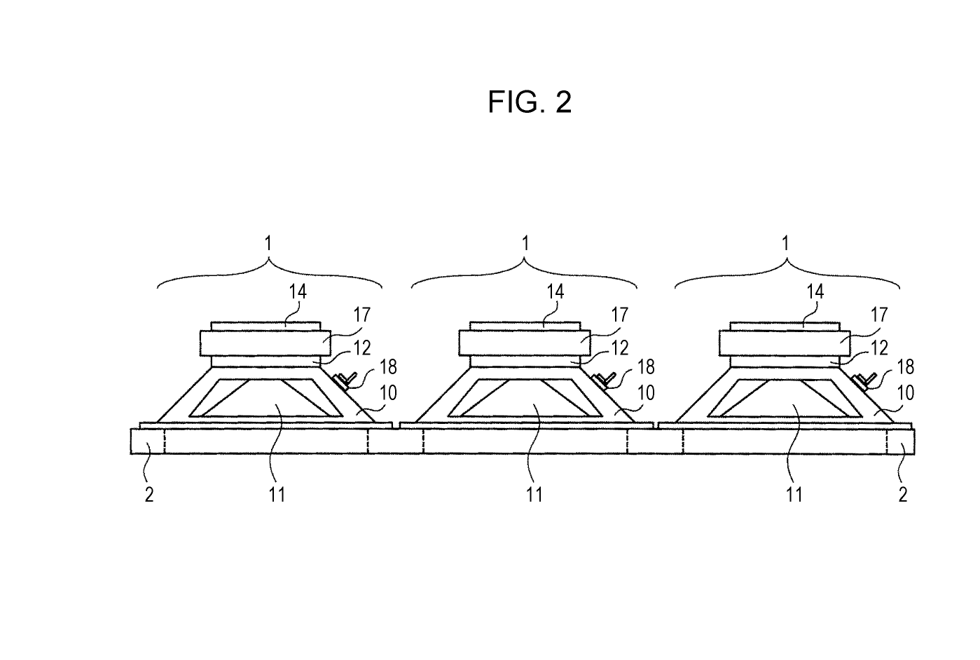

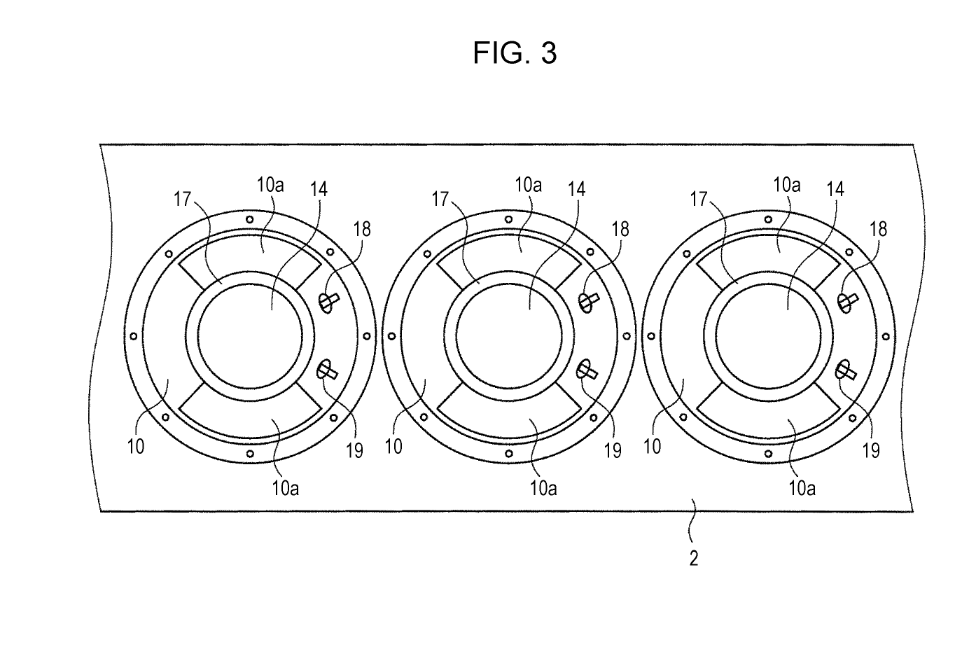

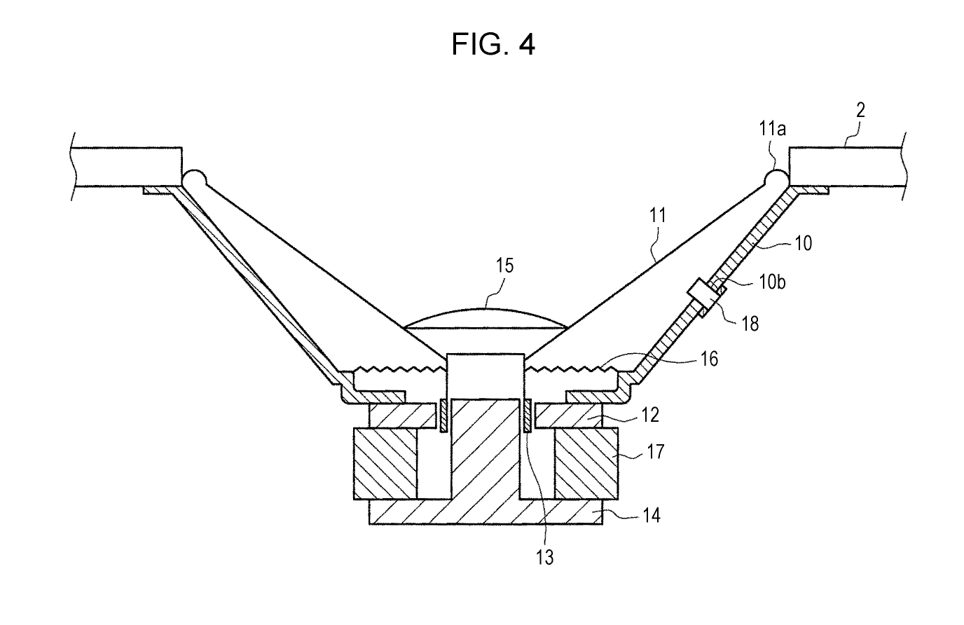

FIGS. 2 and 3 are a schematic top view and a schematic back view, respectively, of the speaker units 1 according to the first embodiment. FIG. 4 is a schematic vertical sectional view of each speaker unit 1 according to the first embodiment. In the figures, reference numeral 10 denotes frames that are formed of steel sheets and that have the shape of a substantially truncated-cone-shaped tube. Trapezoidal openings 10a, 10a are formed in a side surface of each frame 10 at two locations in upper and lower regions of the corresponding speaker unit 1, each opening 10a having a width of 90 degrees in a circumferential direction. The side surface of each frame 10 has no opening 10a in regions along the arrangement direction.

An inner edge of an annular edge portion 11a made of foamed rubber is bonded to a large-diameter-side outer surface of a cone-shaped diaphragm 11 made of pulp. An outer edge of the edge portion 11a is fixed to a large-diameter-side inner surface of the corresponding frame 10. Thus, the frame 10 supports the diaphragm 11 with the edge portion 11a provided therebetween in such a manner that the diaphragm 11 is capable of vibrating.

Here, in each speaker unit 1, two planes are considered, the two planes being obtained by rotating, by 45 degrees, a first plane that includes a central axis passing through the centers of small-diameter and large-diameter portions of the diaphragm 11 and that is perpendicular to the arrangement direction and a second plane that includes the central axis and that is perpendicular to that first plane. Of the four regions of the frame 10 that are divided from each other by the two planes defined as above, two regions arranged in the vertical direction are referred to as upper and lower regions, and two regions arranged in the arrangement direction are referred to as arrangement-direction regions.

A front surface of an annular top plate 12 composed of a soft iron is fixed to a small-diameter portion of the frame 10. A front surface of an annular magnet 17 is fixed to a back surface of the top plate 12. A voice coil 13, which is formed by winding a copper wire around a cylindrical bobbin, is arranged such that the voice coil 13 is concentric with the top plate 12 and the magnet 17 and is movable. A yoke 14 includes a disc portion and a columnar portion that extends from the center of a surface of the disc portion. The columnar portion of the yoke 14 is fitted in the voice coil 13. A back surface of the magnet 17 is fixed to the surface of the disc portion of the yoke 14.

A side surface of a front end portion of the voice coil 13 is bonded to an inner surface of the small-diameter portion of the diaphragm 11. The voice coil 13 and the diaphragm 11 form a funnel-like shape. The small-diameter portion of the diaphragm 11 is covered by a thin dust cap 15. An inner edge of an annular corrugated damper 16 is bonded to a side surface of the front end portion of the voice coil 13, and an outer edge of the corrugated damper 16 is bonded to an inner surface of the small-diameter portion of the frame 10.

Two holes 10b, 10b, which are arranged in the circumferential direction, are formed in one of the arrangement-direction regions of the frame 10. Terminals 18 and 19 are attached to the respective holes 10b, 10b formed at two locations. The terminal 18 is connected to the copper wire included in the voice coil 13 by a flexible wire. The terminals 18 and 19 are insulated from the frame 10. The terminal 19 may be connected to the frame 10.

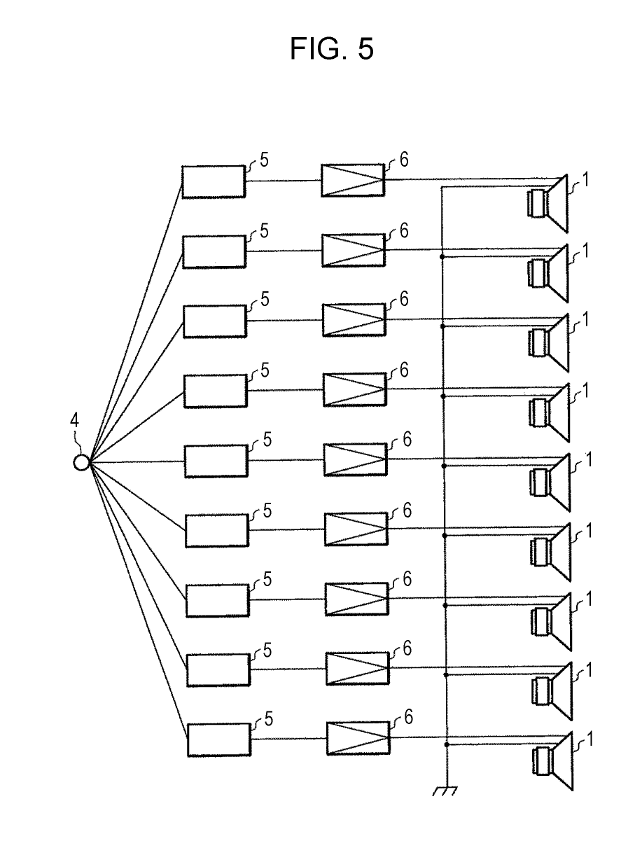

FIG. 5 is a block diagram of an acoustic apparatus including the line array speaker. The acoustic apparatus according to the present embodiment includes delay modules 5, 5, 5, . . . , to which acoustic signals are input from an external sound source 4. A delay time and a gain, which are based on the position of a virtual sound source, are set for each of the delay modules 5, 5, 5, . . . in association with the corresponding one of the speaker units 1, 1, 1, . . . . The delay modules 5, 5, 5, . . . delay the acoustic signals by the respective delay times. The delayed acoustic signals are amplified by the same number of amplifiers 6, 6, 6, . . . as the number of delay modules 5, 5, 5, . . . , and are output to the terminals 18, 18, 18, . . . of the same number of speaker units 1, 1, . . . as the number of delay modules 5, 5, 5, . . . . The voice coil 13 generates an electromagnetic force when the corresponding acoustic signal is input thereto. The diaphragm 11 is vibrated by a force generated by the electromagnetic force and the magnetic force generated by the magnet 17, thereby emitting a sound. When the diaphragm 11 is vibrated, a back pressure is generated in a direction perpendicular to the diaphragm 11. The back pressure is released from the frame 10 through the openings 10a, 10a, but arrangement-direction components of the back pressure are blocked by the side surface of the frame 10.

According to the present embodiment, since the side surface of the frame 10 included in each speaker unit 1 has no opening in the arrangement-direction regions, the interference between back pressures can be reduced. In addition, according to the present embodiment, since the side surface of the frame 10 has no opening in the arrangement-direction regions, the strength of the frame 10 is increased. Accordingly, deflection of the frame 10 is reduced while a sound is being emitted, and vibration of the baffle plate 2 is also reduced as a result. Therefore, reduction in the sound quality can be suppressed.

In addition, according to the present embodiment, since the holes 10b, 10b are formed in the frame 10 and the electrode terminals 18 and 19 are disposed in the holes 10b, 10b, it is not necessary to use a terminal plate that blocks the openings 10a. Furthermore, the area of the side surface of the frame 10 is greater in the arrangement-direction regions than in the upper and lower regions. Therefore, by forming the holes 10b, 10b in the arrangement-direction regions of the side surface of the frame 10, the arrangement-direction regions of the side surface can be effectively utilized.

The material of the frame 10 may be a metal, such as a steel sheet or an aluminum alloy, or a resin material, such as an ABS resin, a polypropylene resin, or a polycarbonate resin. The diaphragm 11 may be composed of a resin or a metal. The edge portion 11a may be composed of urethane or cloth. The voice coil 13 may be composed of a material other than copper, such as aluminum. The structure of a magnetic circuit portion including the voice coil 13, the yoke 14, the magnet 17, and the top plate 12 is not particularly limited, and the magnetic circuit portion may instead have other structures.

The width of each of the openings 10a, 10a in the upper and lower regions in the circumferential direction may be 90 degrees or less. The number and shape of the openings 10a are not particularly limited. The diaphragm 11 may have an elliptical cone shape. The frame 10 may have the shape of a substantially elliptical-cone-shaped tube or a substantially polygonal-pyramid-shaped tube.

### Second Embodiment

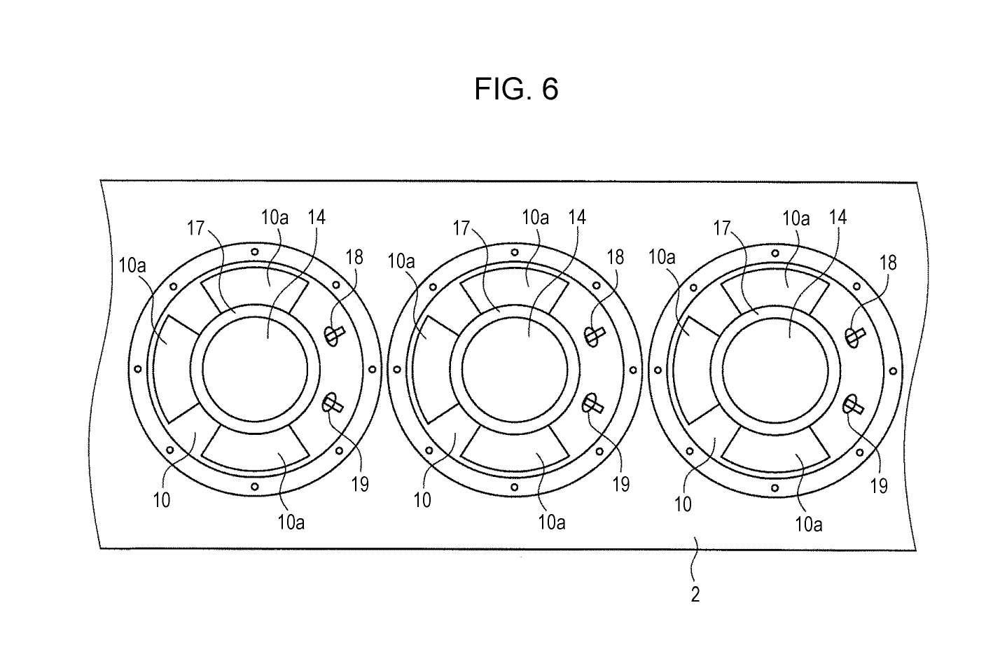

A second embodiment will now be described. FIG. 6 is a schematic back view of a line array speaker according to the second embodiment. In the line array speaker according to the present embodiment, each speaker unit 1 has openings 10a, 10a in upper and lower regions, and also has an opening 10a in only one of arrangement-direction regions.

To appropriately emit a sound from each speaker unit 1, the total area of the openings 10a is preferably as large as possible so that the back pressure can be released without resistance. The interference between back pressures can be reduced as long as the frame 10 of one of the two adjacent speaker units 1, 1 has no opening in the corresponding arrangement-direction region. In the present embodiment, each frame 10 has the openings 10a, 10a in the upper and lower regions and also has the opening 10a in one of the arrangement-direction regions, and no opening is formed in the other one of the arrangement-direction regions.

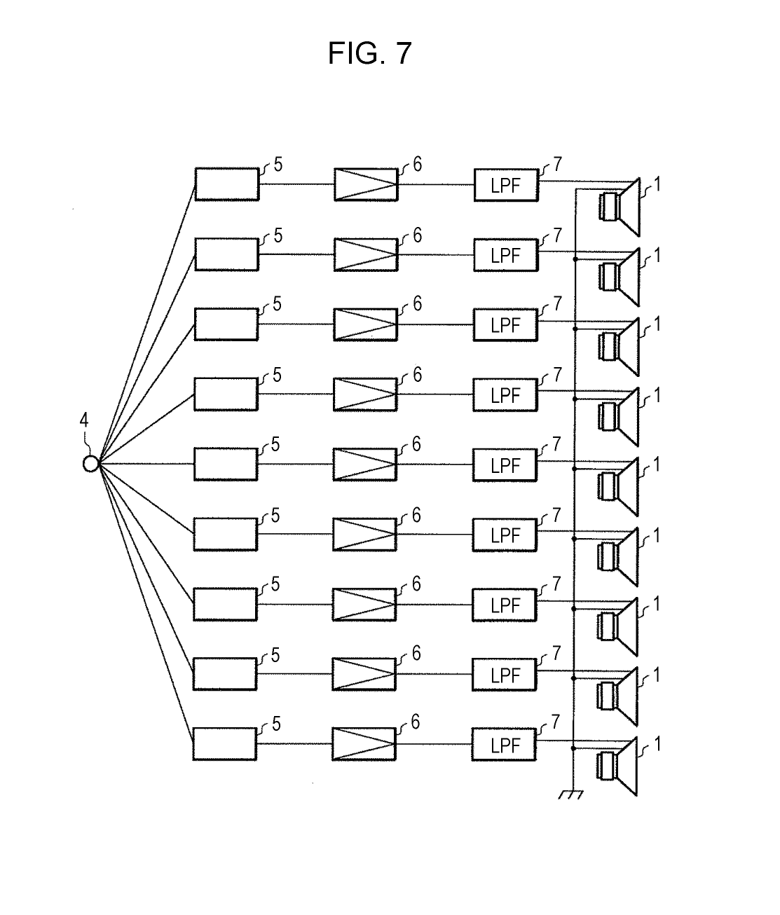

In this case, since each frame 10 has an asymmetrical shape, the diaphragm 11 is nonuniformly deflected when a sound is being emitted, and the emitted sound will be disturbed. The disturbance of the emitted sound is mainly due to high-frequency components. FIG. 7 is a block diagram of an acoustic apparatus including the line array speaker. In this case, to suppress the disturbance of the emitted sound, low pass filters (LPF) 7, 7, 7, . . . may be arranged between the amplifiers 6, 6, 6, . . . and the speaker units 1, 1, . . . of the acoustic apparatus, so that high-frequency components of the sound are not emitted.

According to the present embodiment, each frame 10 has the openings 10a, 10a in the upper and lower regions, and also has the opening 10a in only one of the arrangement-direction regions. Therefore, the interference between back pressures can be reduced. In addition, since the back pressure is also released through one of the arrangement-direction regions, the air resistance applied to the diaphragm 11 can be reduced and sound can be appropriately emitted by the diaphragm 11.

### Third Embodiment

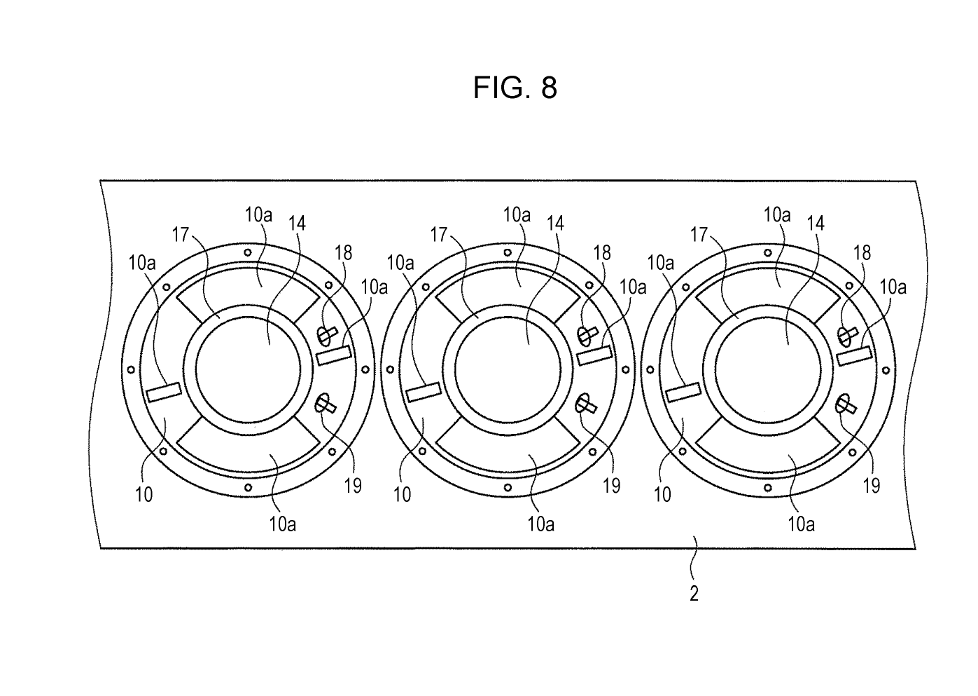

A third embodiment will now be described. FIG. 8 is a schematic back view of a line array speaker according to the third embodiment. In the third embodiment, a frame 10 included in each speaker unit 1 has openings 10a, 10a in upper and lower regions, and also has openings 10a in arrangement-direction regions. The width of each opening 10a, 10a in the arrangement-direction regions in the circumferential direction is 20 degrees.

In the present embodiment, the area of the openings 10a in the arrangement-direction regions is smaller than that of the openings 10a, 10a in the upper and lower regions. Therefore, the interference between the back pressures in the arrangement-direction regions of the adjacent speaker units 1 can be reduced owing to the frames 10. In addition, since each frame 10 releases the back pressure also through the openings 10a, 10a in the arrangement-direction regions to reduce the air resistance of the diaphragm 11, sound can be appropriately emitted by the diaphragm 11. The number and shape of the openings 10a in the upper and lower regions are not particularly limited.

It should be understood that the embodiments disclosed herein are illustrative and not limitative in all aspects. The scope of the present invention is defined not by the foregoing description but by the scope of the claims, and is intended to include meanings equivalent to the scope of the claims and all modifications within the scope. For example, the array speaker according to any of the above-described embodiments may be used not only for the WFS but also to generate an acoustic beam emitted in a certain direction with high directionality or for wavefront synthesis other than the WFS. In addition, the housing 3 may instead be arranged such that the longitudinal direction of the baffle plate 2 is vertical.

### REFERENCE SIGNS LIST

1 speaker unit
2 baffle plate
3 housing
4 sound source
5 delay module
6 amplifier
7 LPF
10 frame
10a opening
10b hole
11 diaphragm
11a edge portion
12 top plate
13 voice coil
14 yoke
15 dust cap
16 corrugated damper
17 magnet
18 terminal
19 terminal

1. A line array speaker comprising three or more cone-shaped speaker units arranged side by side along a single line, characterized in that
each speaker unit includes a frame having no opening in at least one region of a side surface of the frame in an arrangement direction.

2. A line array speaker comprising three or more cone-shaped speaker units arranged side by side along a single line, characterized in that
each speaker unit includes a frame having an opening in a region of a side surface of the frame in an arrangement direction, an area of the opening being smaller than an area of an opening in another region of the side surface.

3. The line array speaker according to claim 1, wherein each speaker unit includes a magnetic circuit portion, and
wherein the frame has a hole, and a signal terminal of the magnetic circuit is attached to the hole.

4. The line array speaker according to claim 3, wherein the hole is formed in the region of the side surface of the frame in the arrangement direction.

5. The line array speaker according to claim 2, wherein each speaker unit includes a magnetic circuit portion, and
wherein the frame has a hole, and a signal terminal of the magnetic circuit is attached to the hole.

6. The line array speaker according to claim 5, wherein the hole is formed in the region of the side surface of the frame in the arrangement direction.
